(19) United States
(12) Patent Application Publication
(10) Pub. No.: US 2007/0203945 A1
(43) Pub. Date: Aug. 30, 2007

(54) Method for integrated media preview, analysis, purchase, and display

(76) Inventor: Gert Hercules Louw, New York, NY (US)

Correspondence Address: Ward & Olivo;Suite 400, 382 Springfield Avenue, Summit, NJ, 07901, US

(21) Appl. No.: 11/364,816

(22) Filed: Feb. 28, 2006

(51) Int. Cl. G06F 17/00

(52) U.S. Cl. 707/104.1

(57) ABSTRACT

Systems and methods for integrated media monitoring are disclosed. The present invention enables users to analyze how a product or service is being advertised or otherwise conveyed to the general public. Via strategically placed servers, the present invention captures multiple types and sources of media for storage and analysis. Analysis includes both closed captioning analysis and human monitoring. Media search parameters are received over a network and a near real-time hit list of occurrences of the parameters are produced and presented to a requesting user. Options for previewing and purchasing matching media segments are presented, along with corresponding reports and coverage analyses. Reports indicate the effectiveness of advertising, the tonality of editorials, and other information useful to a user looking to understand how a product or service is being conveyed to the public via the media.

### FIELD OF THE INVENTION

The present invention relates generally to all forms of disseminated media and, more particularly, to a method for media preview, analysis, purchase, and display over a network, such as the Internet.

### BACKGROUND OF THE INVENTION

Public relations and advertising are crucial to the success of a business and as a result, companies spend large sums of money to advertise products and services via various forms of media. Advertising allows companies to gain a competitive edge in the marketplace, increase company or product exposure, attract potential customers, and develop brand interest. Competitors may also utilize advertising for strategic counter-campaigns, brand repositioning, or other tactical marketing maneuvers. Since advertising is such an important factor in brand reputation, product and service recognition, and overall performance of a business, it is important for a company to effectively manage and monitor the effectiveness of its advertising.

In addition to advertising, companies also expend significant resources on editorial and news coverage. Editorial media, like advertising, has important financial consequences for businesses offering products or services to consumers. Editorial media, such as news coverage on a product, a service introduction or enhancement, product recall information, informative press releases, a market review, article, a media segment, etc., can drastically influence consumer opinion and brand recognition.

Thus, a comprehensive understanding of both advertising and editorial coverage across all forms of disseminated media is crucial to the success of any business. However, historically, systems and methods that allow for media monitoring have been severely limited. Typical media monitoring services do not provide a business with enough information to fully understand how effective its advertising is. For example, traditional media services may be limited in scope or unable to handle multiple sources of media. As another example, many systems can provide only one type of monitoring (e.g., either electronic monitoring or so-called manual monitoring). As a result, there is a need for a more comprehensive method of media monitoring.

Existing electronic broadcast monitoring systems fall into at least three broad categories. The first category requires an identification signal to be inserted into the broadcast material. For example, one current system in the art inserts a modulated code onto an audio frequency sub-carrier. Other systems in the art modulate a code onto a line in the vertical interval of the television video broadcast signal. All systems in this category require the cooperation and participation of the broadcaster. Thus, this system is inherently limited by the broadcaster's acceptance of the system and interest in supporting a commercial system that monitors broadcasts. These systems require an allocation of some signal bandwidth (either audio or video) in the television broadcast signal. It is readily known that many revenue-conscious broadcasters would rather utilize this bandwidth for the generation of proceeds. In addition, the FCC has not reserved or protected any bandwidth for the purpose of program identification via signal augmentation. Without this protection, these systems have no applicability in the marketplace.

A second type of electronic broadcast monitoring analyzes the program content of the broadcast signal for identification purposes. For example, various video and audio signals of a television broadcast may be analyzed to determine program content. Features of broadcast signals are parsed and compared to a database containing features previously extracted from known program segments. To function, such systems require significant information processing and advanced analysis techniques. For example, a system of this type typically requires a continuous Fourier transformation of the broadcast signal being monitored. Powerful, dedicated signal processors and immense amounts of comparison data are also required for this analysis. Further, the information garnered from this analysis is typically limited to the type of program or commercial being broadcast and more specific information, such as what is being spoken, is not obtained. In short, these systems are of little use to those wishing to fully understand how a product is being conveyed to the public.

A final category of broadcast monitoring involves the use of FCC mandated closed captioning (CC) services. In countries that utilize the National Television Systems Committee (NTSC) television system (like the U.S. and Canada) analog television broadcasts are encoded with transcribed audio as native 608 (CEA-608) closed captions. These captions are carried on the two fields of Line 21 of the vertical blanking interval—a part of the television picture that sits just above the visible portion and is usually unseen. Field one contains two closed captioning streams and two text services streams—CC1, CC2, T1, and T2. Field two contains CC3, CC4, T3, and T4. CC1 is most often used to carry verbatim English captions and CC3 is increasingly being used for Spanish-language captions and captions edited for young children. Closed captioning signals are utilized to provide a visual depiction of the information being presented on the audio sub-channel of the television broadcast. The closed captioning signal can be decoded to produce a sequence of alphanumeric characters that form words and sentences, which are typically white block letters within a box-like black background field. The content of these sentences corresponds to the dialog occurring in the television broadcast. The standard closed captioning rate is 480 bits per second, which is formatted as 60 characters per second (8 bits per character).

Due to its remarkable success in the analog broadcast realm, the FCC has also mandated compliance for digital television close captioning (DTVCC). For Advanced Television Systems Committee (ATSC) digital or high-definition programming, three streams are encoded in the video: two are backward compatible Line 21 captions, and the third is a set of up to 63 additional caption streams encoded in CEA-708B format. On Jul. 31, 2000, the FCC issued a Report and Order (R&O) in ET Docket No. 99-254 regarding DTVCC. The R&O amended Part 15 of the FCC Rules, adopting technical standards for the display of closed captioning on digital television receivers. As of Jul. 1, 2002, the FCC also required DTV receiver manufactures to include closed captioning functionality into all DTV devices.

Thus since these closed captioning signals are virtually ubiquitous, this third category of broadcast monitoring relies on the closed captioning text data for classification and analysis of broadcast programs. For example, one known system extracts and decodes Line 21 of standard television broadcast signals in order to parse closed captioning information. A computer system then compares these characters to a known library of captions or keywords. If a match is encountered, the system identifies the program and records an identification number, the station on which the program was broadcast, and the date and time of broadcast. Another known broadcast presentation and editing system utilizes the closed captioning information to locate items of interest. This system matches viewer-defined keywords against an extracted closed captioning text stream from a television broadcast signal. The corresponding segment of the broadcast that matches the viewer-defined search criteria may then be displayed, edited, or saved.

All of the electronic media monitoring techniques described above are limited in scope. For example, the closed captioning systems do not analyze sufficient references for accurate monitoring such as: (1) visual references, (2) contextual references, and (3) grammatical references.

Visual references are references that suggest or allude to a company, brand, product, or service by visual appearance or visual cues without specifically mentioning the reference verbally. For example, if product logos and company locations are used within a media segment; closed caption monitoring will not match media segments containing visual references with the correct monitoring search criteria, keywords, or products.

Contextual references are found when reviewing an entire media segment in context; these references may yield additional information, such as key issues, consumer tendencies, or social trends. In addition, contextual references may include inflection or tonality of a broadcaster's voice, which can often determine if a media segment should be viewed as positive, negative, or neutral. Recognizing tonality and contextual references adds another dimension to traditional media monitoring.

Certain electronic media monitoring systems may misconstrue grammatical references. Since closed captioning often misspells words and captures phrases incorrectly, many sentences analyzed via closed captioning are unintelligible. Such errors can lead to entire segments being misclassified. In addition, since most electronic media monitoring is based on keyword recognition, misspelled words and grammatical idioms that refer to critical mentions of a brand, company, product, or service would not be captured using traditional electronic broadcast monitoring.

Thus, a clear need exists for an integrated method of monitoring all forms of disseminated media, including advertising, images, and editorial content, in a comprehensive and holistic manner. A new media monitoring method is also needed that strategically supplements traditional electronic monitoring techniques with human monitoring and reporting. A method for previewing relevant media segments that match certain user-defined criteria prior to purchase and a simple, unified media purchasing and delivery mechanism are also needed. Finally, a method to view, compile, organize, and analyze broadcast media effectively is also needed where users can quickly sort through coverage that has been delivered based on pre-defined criteria. In short, what is needed is a system and method to enable users to easily monitor, analyze, preview and purchase broadcast coverage of their products or services.

### SUMMARY OF THE INVENTION

The present invention is directed to a novel method of monitoring media, including advertising and editorial content, more effectively and efficiently.

The present invention comprises an integrated method for monitoring, purchasing, displaying and analyzing various forms of broadcast media content. Broadcast media may include any form of disseminated information, including, but not limited to, broadcast news and editorial segments, newspaper and magazine articles, advertisements, billboards, etc. Broadcast media also includes consumer-generated or consumer-derived media, such as Internet discussion boards, groups, and forums, chat rooms, Internet newsgroups, web logs (“blogs”), personal websites, consumer ratings websites and forums, and any other public opinion, public consensus, or related information. Servers strategically positioned in key markets monitor, record, and encode all forms of broadcast media in real-time or near real-time. The captured media is then subject to both closed captioning analysis and human monitoring and reporting to ensure the highest level of media relevance. Users may initiate an almost instantaneous preview of media matching a certain user-defined criteria from a network location and then purchase the media in a high-quality digital format, if desired. Users can also view reports and analyses to quickly gauge how a product or service is being reported to and received by the public.

The present invention thus comprises methods and systems for gathering and viewing media clips, and analyzing these clips to publish reports. Each media clip has associated with it data that may include text, air date, time, station, market, audience figures, and other metrics useful to the user. For example, one such metric is tonality, which may be measured as positive, negative, or neutral. Alternatively, tonality can be measured on a continuum. When a user defines criteria and a search is performed, the system will search through the data associated with media clips and return data for all clips that match the criteria, i.e., “hits” of data that match the criteria. All hits that are found can be stored in a separate database, or identified for separate retrieval. Essentially, a hit is the text associated with a media clip, and a reference to the media clip itself. Another module presents an interactive user interface so that a user can manipulate these hits to, among other things, create presentations, store hits locally, transmit hits to other users, publish hits, analyze hits, search hits, etc. Tools may also be provided to enable a user to transform hits, and the media associated with these hits, into different output formats to be viewed by other users.

The invention can scale so as to allow a user to view and analyze segments of broadcast and other media from all major markets in near-real time via a flexible user interface. The media can be stored, sorted and searched according to various system and user criteria. A user may then log into the system to preview, retrieve or purchase relevant media segments, reports that summarize these segments, and analyses of these segments.

Thus, the invention has a number of advantageous features. For example, with distributed servers across all major markets, the current system is scalable. Further, by using closed captioning analysis in conjunction with human monitoring, the present invention is comprehensive and accurate. In addition, by using advanced video storage, compression, and streaming video, the disclosed system is efficient and cost-effective for end users. Also, by utilizing a flexible user interface, users can easily view, manipulate and publish reports demonstrating advertising effectiveness.

In general, the present invention may include servers strategically positioned in all major markets to capture broadcast data from all available sources. The storage of this data may be distributed, or, alternatively, the data can all be stored at one central location. The servers receive and record broadcast segments as aired from a variety of broadcast feeds. In one embodiment, the segments are then encoded or converted into a format for transmission to storage and processing devices via an IP network.

Second, the present invention may use various types of media monitoring. As described above, most of the prior art systems generally use only one type of electronic media monitoring. The system of the present invention may incorporate any number of methods of monitoring, including closed captioned analysis, human monitoring of video, speech to text analysis of radio and TV, Internet monitoring, OCR scanning, etc. Thus, for each segment of media, the system may employ multiple analyses to provide a thorough analysis of the particular media. For example, in a broadcast media environment, a combination of closed captioning analysis and human monitoring can be used. Closed captioning analysis can capture every segment of media where a certain word or phrase was uttered and human monitoring can be used to capture other references to the product and to ascertain whether a clip speaks about a product positively, negatively, or in a neutral manner.

Third, the present invention uses techniques to quickly provide video preview or review to the user. In a preferred embodiment, the strategically placed servers capture and compress media from a variety of sources. Compression formats include, but are not limited to, WMV, AGF, and MPEG. The media is then sent via a connection to facilities for analysis. The analysis is then performed according to user defined criteria. Media clips then become available to the user for preview or purchase in near real-time.

Finally, one of the advantages of the invention is that it presents a user-friendly interface to each user. In one embodiment, the interface may be web-based. From this interface, the user will have the ability to review reports, preview media segments, purchase media segments and organize presentations of media clips and reports. To enable this interface, segments may be encoded or converted into a streaming media format suitable for Internet transmission and immediately made available to subscribers. Thus, users of the present invention may preview advertising and editorial coverage in near real-time from anywhere in the world via an Internet connection.

The reporting features of the present invention allow advertisers, and the like, to understand how products or services are being received by the general public. For example, advertisers can determine whether editorials are generally positive, negative, or neutral with respect to discussions of a product or service. As another example, advertisers can evaluate and predict the estimated audience that might view a commercial about a particular product or service. As yet another example, advertisers can monitor Internet chat rooms and blogs related to discussions about products or services. The invention provides a user interface through which all of this information can be organized, viewed and downloaded quickly and easily. In addition, reports can be generated and shared which summarize this information.

### Typical User Interaction with the System

Generally, a user commences interaction with the system by providing specific log-in criteria. Once logged in, the system presents an overview of the user's hits, including any new hits that have been captured by the system since the user's last login. Of course, the system can also email new hit notifications to the user so the user is aware of when updates are available. The login procedure ensures that the system is secure and that a user accesses the hits, media clips, collections of hits, and reports specific to that user.

Next, the system allows a user to preview, manipulate, store, organize, search, transmit, and share hits and media clips associated with these hits. For example, after logging in, a user may be able to view all new hits since a last login, search for old hits, view all hits sorted by various criteria, query a database for hits, and search for hits as desired. The user can then preview the media clip for any given hit, view information about a hit, create collections of hits, purchase hits and media clips, organize media clips, etc. In the present invention, more than one type of media clip may be attached to each hit. For example, a series of thumbnail images, a low-quality preview clip, and a high-quality video clip can all be associated with the same hit. In this way, when a user selects a particular hit, the user can choose to preview the hit, quickly look at a few images that comprise the hit, or purchase a high quality version of the hit. In short, any type of media clip can be associated with a hit. Further, a hit may comprise an advertisement, editorial content, or any other type of media compatible with the present invention. The system thus provides a flexible, extensive user interface which allows a user to quickly search for, organize, and analyze media clips.

A user will also be given the option to purchase media clips associated with hits. If the user chooses to purchase the media clip associated with hit, the system can deliver the clip via download, email, ftp, or other similar modes. After purchase, the user may also “publish” the media clip so it is available to be viewed by other users. Purchase can be accomplished through a user interface that provides standard purchasing modules including “shopping carts”, “ordering forms”, download pages, etc. The back-end of the ordering systems can also be handled via standard client order systems so as to allow ordering via credit cards, money orders, pay-pal, or similar modes of payment.

In addition to presenting hits and media clips, the system is capable of generating reports, charts, graphs, and other analytics about how a user's product or service is being conveyed to the public. Reports are generally created via manipulation and analysis of collections of hits. The user interface allows a user to view and interact with such collections. Indeed, one of the features of the present invention is to provide a user interface that enables users to view and interact with hits and collections of hits. The user can select hits, perform operations on the selected hits including moving a hit to a new or existing collection, copying a hit to a new or existing collection, purchasing a hit, deleting a hit, or editing the content of a hit. Similarly, a user can to manipulate and view collections of hits, including creating new collections, renaming collections, moving collections, deleting collections, making reports from collections and publishing collections. The user has an option of purchasing the collection, or presenting the collection to guests or other users.

To aid in the presentation of collections, a tool, herein referred to as a “renderer” may transform a collection of hits into a presentable form for the client. This information may then be reported or published. Reporting and publishing involves transforming the collection into a form that can be viewed or manipulated. For example, a report may include charts and graphs, documents, presentations, interactive web-pages, lists of hits with available media clips, PDF documents, play-lists of clips, slideshows, XML files, etc. Publishing is similar, and allows reports to be viewed by others. For example, an advertising executive may want to publish a report to a client to show how effective advertising of the client's product has been. Renderers can create reports that have user-specifiable parameters that control what is included in each report. For example, a monitoring report renderer may have parameters to determine whether the user wants to include audience figures and other similar metrics. It can also analyze style sheets and customer specific layout definitions (i.e., it is fully customizable).

A user generates reports according to any selectable criteria. The user can then create a collection of such reports (herein referred to as a “showroom” of reports). These showrooms can be sent to customers, clients, other users, etc. to demonstrate how a product is being viewed. A showroom can also be displayed, e.g., on a webpage for future viewing.

Users may also have the option of making collections dynamic. Specifically, as more hits are captured by the system, the published collection may be updated automatically. Dynamic updating has a number advantages. First, users do not have to re-render collections of data each time there is a new hit. Also, users and guests can watch for trends, and view whether there are significant changes in advertising effectiveness over time. Users can define thresholds that will trigger automatic alerting. The present invention can also produce reports in a “Really Simple Syndication” (“RSS”) format, publishing new hits as a constantly-updated RSS feed.

### System Architecture

To implement these various features, in a preferred embodiment, the system is composed of a series of building blocks, including (1) a client facing portal that provides client access, an interface with authentication services and presentation services; (2) a storage system for storing client “hits”; (3) a means of delivering client hits to the storage system; (4) tools to allow a user to view, select, combine and publish hits; (5) tools to transform collections of hits into different output formats; and (6) tools to allow the user to administer access for other users and guests. With these building blocks or tools, the system with all of the above features and advantages can be built to provide a more effective means of analyzing the effectiveness of product public relations or advertising.

Therefore, it is an object of the invention to provide a method of monitoring media so that users are presented with reports indicative of the effectiveness of a user's advertising.

It is another object of the invention to provide a method of media monitoring that captures and analyzes media clips from multiple sources of media, where meta-data is associated with each clip.

It is yet another object of the invention to provide a user interface through which users can search for clips of media satisfying certain criteria.

It is still another object of the invention to provide a user interface that enables a user to render reports indicative of how a user's advertising is being received by the public.

Additionally, it is an object of the present invention to provide a mechanism allowing users to publish reports indicative of the effectiveness of a user's advertising.

It is yet another object of the present invention to provide a mechanism for searching and analyzing broadcast media from all major television markets.

It is another object of the invention to provide a method of monitoring media so that results matching user-defined criteria are more relevant and yield more information.

Another object of the present invention is to provide an automatic method of classifying media content utilizing closed captioning information as well as human monitoring and reporting.

It is another object of the present invention to provide a method of previewing and displaying digital media segments over a network before purchase.

Another object of the present invention is to provide a novel method for purchasing high-quality digital media segments over a network.

Other objects, features, and characteristics of the present invention, as well as the methods of operation and functions of the related elements of the structure, and the combination of parts and economies of manufacture, will become more apparent upon consideration of the following detailed description with reference to the accompanying drawings.

### BRIEF DESCRIPTION OF THE DRAWINGS

A further understanding of the present invention can be obtained by reference to a preferred embodiment and various alternate embodiments related hereto as set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the specific methods and instrumentalities disclosed.

For a more complete understanding of the present invention, reference is now made to the following drawings in which:

FIG. 1 is a schematic block diagram of the architecture used to implement the integrated media intelligence method in accordance with the preferred embodiment of the present invention;

FIG. 2 is a schematic diagram depicting the various forms of media coverage which may be monitored by the comprehensive monitoring method in accordance with the preferred embodiment of the present invention;

FIG. 3 is a flow diagram of a routine for viewing and displaying media hit lists and reports in accordance with one embodiment of the present invention;

FIG. 4 depicts a flow diagram of a routine for previewing and purchasing digital media segments in accordance with one embodiment of the present invention;

FIG. 5 depicts a sample web-based interface which allows a user to summarily view hits matching specific search criteria in accordance with one embodiment of the present invention;

FIG. 6 depicts a sample web-based user interface which allows a user to preview digital media segments and to review analyses of various media hits in accordance with one embodiment of the present invention;

FIG. 7 depicts a sample web-based user interface which allows a user to view and edit the content of a hit which is associated with a media clip in accordance with one embodiment of the present invention;

FIG. 8 depicts a sample web-based user interface which presents various charts and graphs that report on the media coverage and advertising of a product or service in accordance with one embodiment of the present invention;

FIG. 9 depicts a sample report indicating the audience size that viewed an advertisement or other media segment concerning a specific product in accordance with one embodiment of the present invention;

FIG. 10 depicts a sample report indicating the coverage summary of an advertisement or other media segment concerning a specific product in accordance with one embodiment of the present invention;

FIG. 11 depicts a sample report indicating the coverage timeline of an advertisement or other media segment concerning a specific product in accordance with one embodiment of the present invention;

FIG. 12 depicts a sample report indicating the tone timeline of an advertisement or other media segment concerning a specific product in accordance with one embodiment of the present invention;

FIG. 13 depicts a sample report indicating the broadcast media breakdown of an advertisement or other media segment concerning a specific product in accordance with one embodiment of the present invention;

FIG. 14 depicts a sample coverage summary table for an advertisement or other media segment concerning a specific product in accordance with one embodiment of the present invention;

FIG. 15 depicts a sample web-based interface which allows a user to manage media clips and hits in accordance with one embodiment of the present invention;

FIG. 16 depicts a sample web-based interface which allows a user to add media clips to a shopping cart for purchase in accordance with one embodiment of the present invention;

FIG. 17 depicts a sample web-based interface which allows a user to manage additional user and guest accounts in accordance with one embodiment of the present invention;

FIG. 18 depicts the architecture of the renderers employed by the system of the present invention to generate collections, reports, tables and graphs in accordance with one embodiment of the present invention; and

FIG. 19 is a table illustrating the types of available displays of monitored media segments in accordance with one embodiment of the present invention.

### DETAILED DESCRIPTION OF THE PREFERRED EMBODIMENTS

As required, a detailed illustrative embodiment of the present invention is disclosed herein. However, techniques, systems, and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for the purposes of disclosure and to provide a basis for the claims herein, which define the scope of the present invention. The following presents a detailed description of a preferred embodiment (as well as some alternative embodiments) of the present invention.

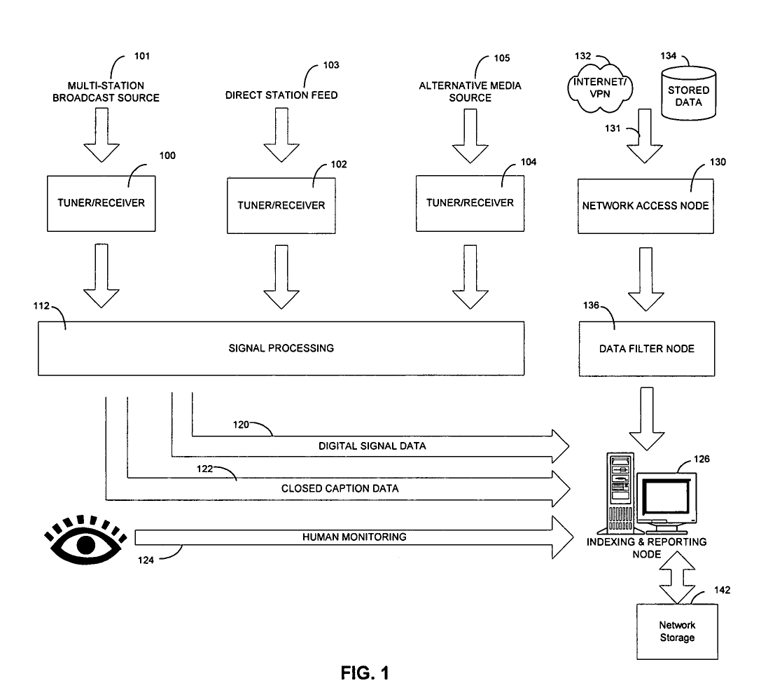

Referring to the drawings wherein like numerals indicate like elements throughout, FIG. 1 is a schematic block diagram of the integrated media monitoring method in accordance with one embodiment of the present invention. Tuner/receiver 100 receives analog or digital signals from external sources 101. For example, tuner/receiver 100 may receive a multi-station broadcast coaxial transmission from a cable television network. Alternatively, tuner/receiver 100 may receive a multi-station broadcast source from an atmospheric transmission, including satellite, microwave, UHF, or any other wireless or facilities-based signal transmission mechanism. The transmission itself may comprise DTV, DVB, or analog signals, as well as any other broadcast transmission signal used for broadcast media. Broadcast media comprises all forms of disseminated media, including, but not limited to, broadcast news and editorial segments, newspaper and magazine articles, advertisements, billboards, etc. Broadcast media also explicitly includes consumer-generated or consumer-derived media, such as Internet discussion boards, groups, and forums, chat rooms, Internet newsgroups, web logs (blogs), personal websites, consumer ratings websites and forums, and any other public opinion, public consensus, or related information.

Similarly, tuner/receiver 102 may receive direct single-station feed 103 via any transmission mechanism, including high speed optical fiber and satellite links. Tuner/receiver 104 may receive various forms of mixed or alternative broadcast media 105, including satellite radio media, etc. As is common in the art, tuner/receivers 100, 102, and 104 may demodulate the signal, if required, and output the demodulated signal to signal processing node 112. Signal processing node 112 may comprise a closed captioning decoder for extracting a closed caption stream of textual data from a broadcast signal, if one exists. Typically, the closed captioning decoder extracts information from Line 21 of the vertical blanking interval of the broadcast signal and converts this information into a text stream, although other forms of closed captioning decoding may also be utilized without departing from the spirit of the present invention. Signal processing node 112 outputs digital signal stream 120 and closed caption stream 122. These two streams, along with human monitoring stream 124 are received by indexing and reporting node 126. Human monitoring stream 124 supplements the closed captioning data in order to provide more comprehensive reports and closer media content matches. For example, human monitors may analyze speaker tonality, media relevance, and other factors in order to classify each media segment as positive, negative, or neutral. Human monitors may also document grammatical, contextual, and visual-only references that closed caption monitoring may miss and record various other human-perceivable attributes of the media segment.

Signal processing node 112 may also comprise other processing modules to extract information from non-broadcast sources of media. For example, signal processing node 112 may comprise speech to text processors or software to extract text uttered on the radio. As another example, signal processing node 112 may comprise OCR software to extract information from print sources of media, as discussed below.

The system of the present invention can also receive data from sources such as the Internet, other third parties, print media, etc. In the embodiment depicted in FIG. 1, this data is received by network access node 130 from Internet VPN 132 and stored data 134. Network access node 130 may also access a broad array of external data. Stored data 134 may be maintained by a media provider, the monitoring service provider, or a third-party. For example, stored data 134 may comprise market or product data, consumer satisfaction surveys, and other stored analyses and product information. Stored data 134 may additionally comprise subscriber search or keyword criteria and various forms of media comparison data, including closed captioning associations. Internet/VPN 132 may be a source of continuous Internet media, such as web logs (blogs), forums, chat rooms, newsgroups, electronic bulletin boards, etc., which all may be monitored and/or recorded by the media monitoring method of the present invention.

In the preferred embodiment, network access node 130 comprises high-speed fiber optic OC-3 data link 131 to Internet/VPN 132 and stored data 134, but any network access mechanism exhibiting any data transfer rate may be utilized, as appropriate. OC-3 data link 131 is preferred because it allows for faster transfer of data from Internet VPN 132 and stored data 134. Data received via network access node 130 is screened by data filter node 136. Data filter node 136 may comprise a packet filter, firewall, or other network filtering device that processes incoming network data from the network access stream. Data filter node 136 may comprise advanced filtering and media recognition functions, such as automated media and broadcast designation routines. Data filter node 136 and network access node 130 may optionally be integrated within indexing and reporting node 126.

Indexing and reporting node 126 analyzes all incoming data streams for relevant media. Indexing and reporting node 126 matches this media to a valid user system-defined search criteria, including conceptual, contextual and artificial intelligence generated searches. Indexing and reporting node 126 may additionally utilize data from various other sources. Relevant media may be indexed, catalogued, or stored within indexing and reporting node 126 or network storage 142. Due to the potentially voluminous size of the captured media, well-known video and data compression schemes are typically implemented. Indexing and reporting node 126 may also generate various related reports and analyses pertaining to the captured media, including editorial and advertising chronologies and histories, market share forecasts, impression counts, tonality charts, estimated ad value equivalency, media coverage maps, as well as full text summaries and abstracts of the captured media.

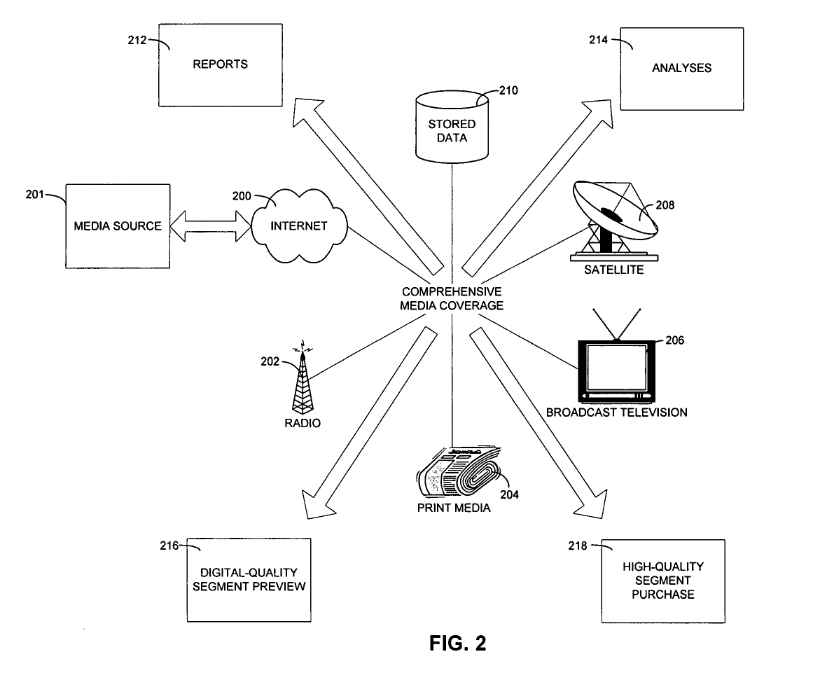

Now referring to FIG. 2, some of the various forms of media that may be monitored utilizing the present invention are shown. It should be noted that the present invention is not limited to monitoring these types of media. Instead they are depicted as exemplary monitoring sources only. The present invention comprises a comprehensive media monitoring solution for monitoring and analyzing all forms of disseminated, published, or broadcast media. Electronic media, often in the form of Internet and private company intranet media, is accessed via Internet 200. As is common in the art, confidential or proprietary media may be accessed securely via Internet 200 through the use of such standards as Secure Sockets Layer (SSL), Transport Layer Security (TLS), HTTPS, secure FTP, or any other encrypted or otherwise protected communication. In addition, a Virtual Private Network (VPN) may be utilized to create secure tunnel connections between devices communicating over a public network (such as Internet 200). Internet 200 also allows access to a broad array of other electronic media, including Internet discussion boards, groups, and forums, chat rooms, Internet television (IPTV), Internet newsgroups, web logs (blogs), podcasts, personal websites, consumer ratings websites and forums, and any other public opinion, public consensus, or related information (collectively depicted as Internet media source 201). All of the foregoing electronic media may be searched and analyzed for specific user-defined or system-defined keywords or phrases and recorded in accordance with the present invention.

The present invention is also capable of monitoring media from radio 202, print media 204, broadcast media 206, satellite 208 and other sources of data such as stored data 210. Radio transmissions include AM band radio, FM band radio, short wave radio, single sideband (SS) radio, continuous wave (CW) radio, radioteletype (RTTY), packet radio, and any other type of radio transmission. The received radio transmissions are demodulated (if required) and analyzed. Alternatively, foreign language translators can be applied. Speech-to-text engines or voice recognition software may be utilized to produce searchable text of radio segments. This searchable text stream allows for user-defined or system-defined keyword matching. Radio segments matching a specific search criteria are recorded for later access by subscribers of the present invention.

The present invention is also compatible with print media 204. Newspapers, magazines, journals, consumer reports, billboards, and any other printed matter may be parsed and searched for applicable user-defined or system-defined keywords. Searching of print media typically involves the conversion of print media 204 into electronic form. As is common in the art, various scanning techniques may be utilized to convert print media 204 into electronic form. These conversion routines may include optical character recognition (OCR), digital image scanning, various pattern recognition engines, or any other optical or digital recognition. Print media 204 may also comprise a printed feature, such as a barcode, watermark, or hologram, to assist in the electronic conversion, media identification or recognition process. For example, to simplify media identification, a barcode embedded or printed within printed media 204 may allow automatic access to a database of stored information related to printed media 204. Alternatively, the barcode or other printed feature associated with printed media 204 may contain complete identification data in encoded form.

Media intelligence may also be derived from broadcast television 206. Broadcast television 206 includes any single-source or multi-station analog or digital television feed, including, but not limited to, UHF, VHF, DTV, HDTV, and cable television services. Closed captioning data obtained from Line 21 of the vertical blanking interval (or any other closed captioning format or service) may be utilized to classify broadcast television media segments. For example, closed captioning streams may be searched for a relevant keyword search criterion. Segments matching particular user-defined or system-defined criteria may then be indexed, recorded, or further analyzed.

Satellite data, including satellite radio data and direct-to-home (DTH) satellite television data, can also be monitored from a source such as satellite 208. Similar to broadcast television 206 and radio 202, media transmission via satellite 208 may be electronically analyzed via closed captioning data or speech-to-text engines, as appropriate. In addition, as described above, the system supports human monitoring of all sources of media.

Disseminated media compatible with the present invention may also include stored data 210. Stored data 210 may comprise, for example, market or product data, consumer satisfaction surveys, and other stored analyses and product information. This data may reside in databases, files, or any other computer readable medium. Stored data 210 may additionally comprise product or market sector analyses, product or service distribution tables, or any other stored information related to a product, service, brand, or company.

The present invention thus provides comprehensive media coverage across all forms of disseminated media, including Internet 200, radio 202, print media 204, broadcast television 206, satellite 208, and stored data 210. From these media streams, the present invention creates media reports 212 and analyses 214. Users are able to search for relevant media—including news, editorial, and advertising—by numerous search criteria, including region, date range, content, ad value equivalency, and estimated audience. Media reports 212 may include an overview of all media coverage matching a certain criteria with links to the actual media content. For example, a daily report on a company's total media coverage (or a competitor's media coverage) for the current day can be accessed via media reports 212. Media reports 212 may also comprise links to full-text print stories, broadcast video and radio clips, scanned graphics and advertisements, web coverage, and transcripts. Media reports 212 also support media coverage tracking by time period, such as monthly clipping reports, etc. Additionally, media reports 212 may detail levels of media coverage in different media segments and various geographic regions, as requested by a user of the present invention.

Analysis node 214 allows users to search, filter, track, chart, and compile data related to media segments. Human monitors may additionally tag each media segment with keyword descriptors relating to tone, market, content, author, etc. By utilizing these descriptors, analysis node 214 permits access to media comparison charts, tables, and graphs. These charts, tables, and graphs measure and compare various user-defined or system-defined criteria. For example, impression count, tonality, and ad value equivalency (AVE) can be used to track, chart, and analyze media coverage over time or by market region or sector. In addition, coverage summary tables, tracking charts, and graphs can be generated and displayed. Analysis node 214 may also generate reports on selected competitor media activity. These competitor reports may be tracked by author, publication, media segment, etc. Analysis node 214 also provides one-click access to media summaries and recent media activity data.

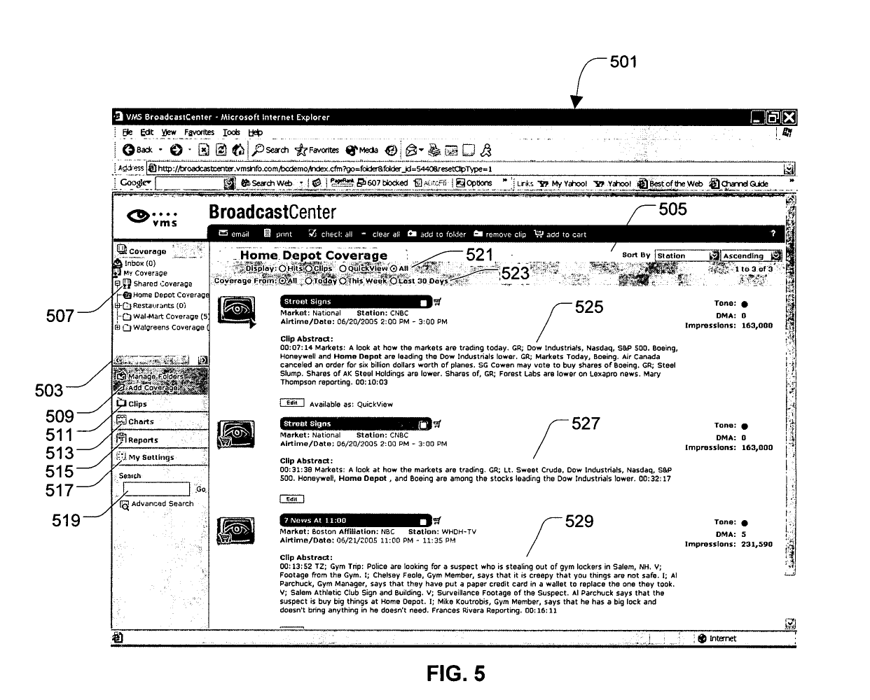

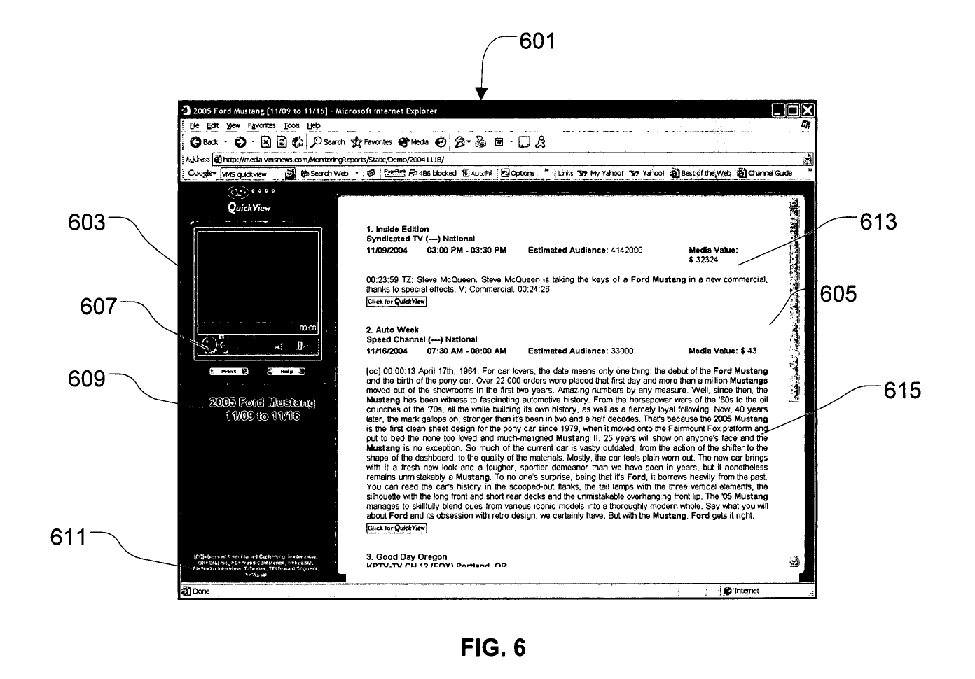

Digital-quality segment preview 216 allows for near real-time viewing of media clips (e.g., broadcast news clips) via an interface. A web-based interface connects to an Internet server for streaming of digital-quality video and audio. The streaming media may be presented within a standard web browser as a Windows Media, RealTime (Real Video/Real Audio), QuickTime, MPEG, Flash, or similar media clip. An example of a web-based user interface is shown and discussed in more detail with respect to FIGS. 5-6, infra. News monitors and editors may additionally view the monitored media clips and produce cogent summaries and synopses. These summaries and synopses may be presented to a user in a reading pane before the steaming media clip is previewed. In this way, only relevant media clips are previewed, saving valuable bandwidth, time and user costs. Abstracts of media segments are also available. The summary pane may additionally include pertinent information about the media clip about to be previewed, including date, time, and station(s) aired, title, length, author, estimated audience, ad value equivalency, tonality, etc.

Previewing of digital-quality segments is made possible by servers strategically positioned in key markets throughout the media monitoring coverage area. These servers receive and record broadcast segments as aired from a variety of broadcast feeds. The segments are encoded or converted into a streaming media format suitable for Internet transmission and immediately made available to subscribers. This way, users of the present invention may preview advertising and editorial coverage in near real-time from anywhere in the world via an Internet connection.

Digital-quality segment preview 216 may also include thumbnail storyboard displays. In the preferred embodiment, these unique displays are comprised of sampled frames of a broadcast editorial, news, or advertising segment disposed side-by-side in a tabular layout. In a preferred embodiment, human monitors ensure that only the most critical frames are displayed. However, any convenient layout and frame sampling scheme may be utilized. The storyboards may include graphic shot-by-shot post-production frame thumbnails with a corresponding, full-text transcript for each frame displayed beneath each still frame. Storyboards are a convenient way to efficiently deliver and analyze subtle details of media segments. Frames for storyboard production may be sampled electronically (e.g., every 10 frames) or sampled for key frames chosen to illustrate the essence of the segment. Storyboard sample rates and the actual frames sampled may be changed at any time by a requesting user, the system, or a third party. Storyboards may be presented electronically (e.g., in Adobe PDF or other convenient document format, within a webpage, or via email as an attachment or inline graphic). Alternatively, color printed storyboards may be delivered via postal mail to a requesting user.

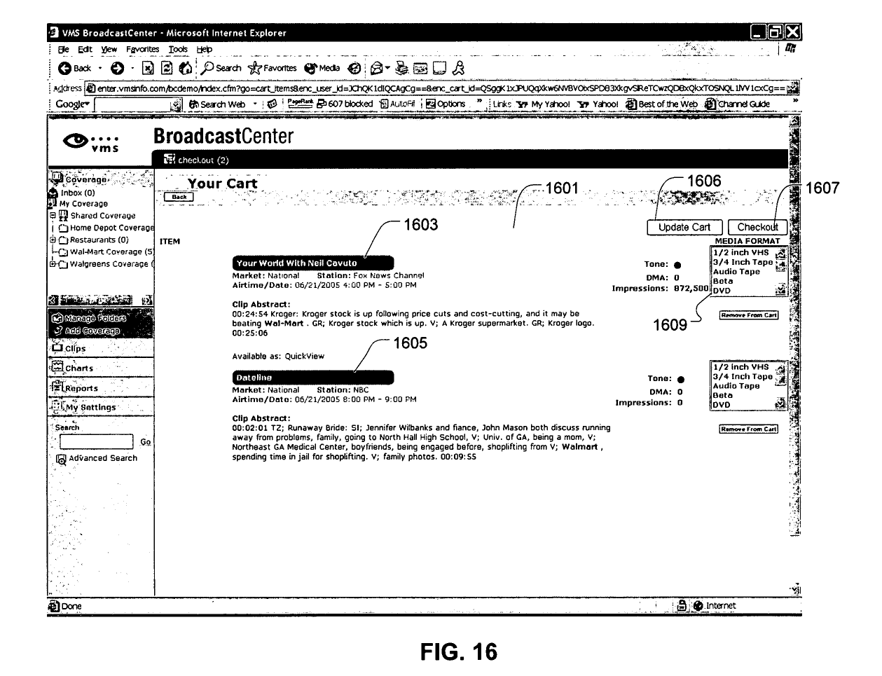

Still referring to FIG. 2, media clips may optionally be purchased via high-quality segment purchase node 218. After previewing relevant matches via digital-quality segment preview 216, an option may be provided for high-quality media purchase. A sample web-based interface for purchasing media clips and reports is discussed with respect to FIG. 16 infra. The media available for purchase may be encoded at a higher quality (e.g., higher frame rate, increased color depth or resolution, higher-quality audio, or larger video size) than the media available for preview. (Preferably, preview media is of a lower quality so that it can be quickly streamed to a user, even if the requesting user has a limited bandwidth connection to the system). In addition, purchased media may be viewed and downloaded to disk, whereas previewed media (which is streamed to a user) is generally not available for download. High-quality segment purchase node 218 may verify or validate a user's account for good-standing, available credit, etc. before delivering a high-quality media clip for purchase. In the preferred embodiment, the high-quality media clip is delivered over the Internet as a secure HTTP or FTP download. However, high-quality video may be purchased and delivered in various other ways, including via email, instant message transfer, postal mail, wireless network, blue tooth, etc. In lieu of validating an account, high-quality segment purchase node 218 may prompt the user for purchasing information on a per-purchase basis. Purchasing may also be handled by a third party (e.g., a credit card company, PayPal, etc.).

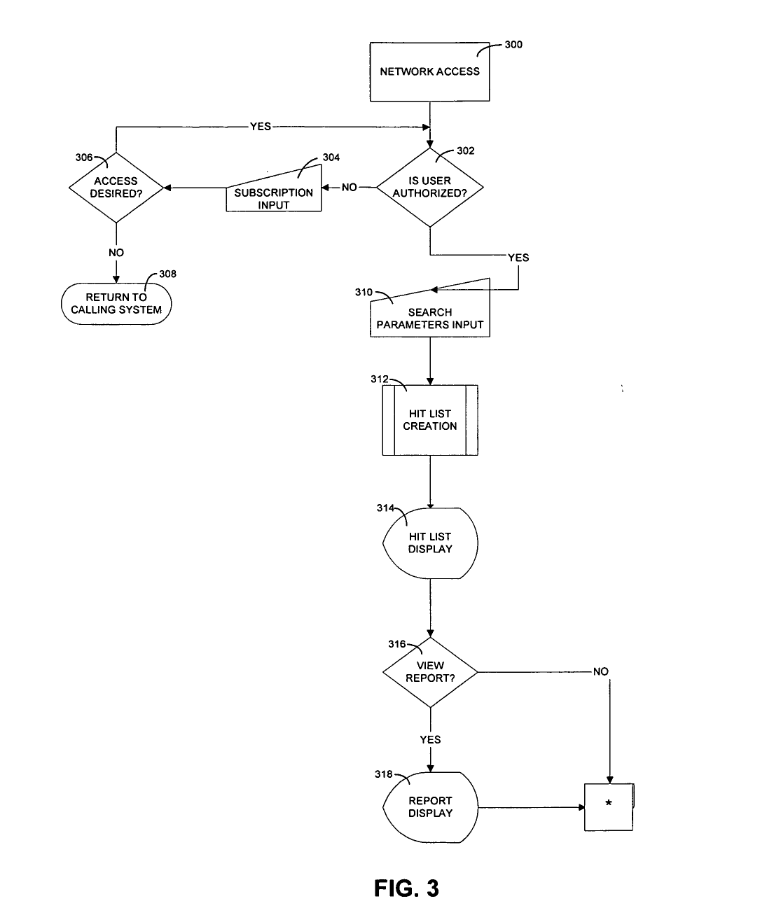

Now referring to FIG. 3, a flow diagram of a routine for viewing and displaying media hit lists and reports is shown. The first step in the routine is accessing the network at network access stage 300. This typically involves establishing a connection to the system of the present invention via a public network connection (e.g., the Internet), or via private network access (e.g., via VPN). For additional security, this connection may be encrypted or secure. A user accessing the media monitoring service is authorized at authorization stage 302. This step may comprise the submission of a username and password combination or any other conditional access technique common in the art. Users may also establish “guest” accounts to allow others limited access to the system. One application of a guest account would be if an advertising company wanted to show a customer how effective an advertising campaign is. The advertising company would establish a guest account for the customer to allow the customer to, e.g., view reports created by the advertiser.

If the user is not presently authorized, and is not a guest, the user may subscribe to the service at subscription input 304. Billing information, such as a credit card number and/or account information may be validated and the user may create an account to access the service. After subscription input 304 is submitted, the present invention may determine if access to the service is now desired at access desired stage 306. If access to the service is not desired, the system returns the user to the calling system or web page at return stage 308. If access desired stage 306 determines that access is now desired to the service, the user is returned to authorization stage 302 so that the user may login to the service.

After a user successfully logs into the system, the user can access hit results, including media segments, comments about those media segments, reports, graphs, charts etc. Alternatively, a user can also create or modify search criteria used by the system to generate hit lists. If a user wishes to create or modify a hit list, the first step is completed at search parameters input 310. At this input, the user may enter criteria for media searching. For example, a user might search by type of media, content, author, date and time, station, tone, market, impression count, ad value equivalency, estimated viewing audience, concept, etc. For example, a user can search for a concept in an autocluster, which groups date on the same concept (e.g., the color blue). The user may specify various filter criteria at search parameters input 310. Filter criteria may be system-defined or user-defined and may further limit a media search, such as an autocluster. For example, a user may establish a filter to exclude all print media. Logical connectors (e.g., AND, OR, LESS THAN, GREATER THAN, EQUAL TO, STARTS WITH, CONTAINS, etc.) may be used to create complex filter strings, or logical filter expressions. Different search terms and parameters can be used for different types of media. Available search and filter criteria may be added, deleted, or edited at any time by the system, the user, or a third-party. In addition, search criteria may be partially system-derived. For example, monitoring threads may be established prior to or during authorization stage 302. These threads may limit or define media availability on a per-user basis and may act as media boundaries. These threads may be limited to a certain type of media content, a certain product, service, market, or industry, or any other convenient criteria. In this manner, subscribers can be restricted only to monitored media channels to which a user has subscribed.

After a desired search criteria is entered at search parameters input 310, the present invention searches and develops a hit list of matching media at hit list creation 312. Hit list creation 312 may consult indexed databases, stored information, or other servers to perform the media search. This hit list is then displayed to a user at hit list display 314 and sorted or clustered in various ways. Certain media hits may be hidden from display, depending on the authorization level or account status of the user. For example, the system may not display media types that the user has not subscribed to or paid the service to monitor. If a guest has logged in, that guest may be similarly limited to a certain subset of available media segments.

From the available hit list display, a user may elect to view a media report at view report stage 316. If a media report is desired, report display 318 displays the desired report (e.g., directly in the user's browser). Report display 318 may comprise links to full-text print stories, broadcast video and radio clips, graphics, web coverage, and transcripts. Additionally, report display 318 may detail levels of media coverage in different media segments and various geographic regions, as requested by a user of the present invention.

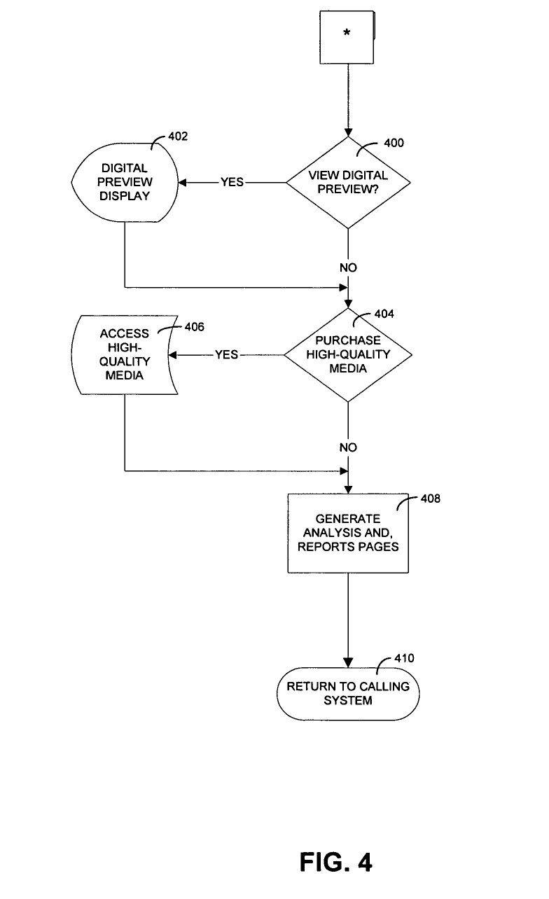

Turning next to FIG. 4, depicted is a continuation of the flow diagram of FIG. 3 as depicted by the “*” nodes of each figure. A user has the option to preview media at digital preview stage 400. If a media preview is desired, the user is presented with digital preview display 402. This display may comprise a streaming segment of all or a part of a media clip of interest. For example, a Windows Media, RealTime (Real Video/Real Audio), QuickTime, MPEG, Flash, or similar media clip may be streamed directly within the user's browser. As described above, it is preferred that the video to be previewed is of limited quality for at least two reasons. First, a limited quality presentation encourages users to purchase the higher quality version of the media, and second it enables previewed segments to stream quickly to users, even if the user only has a limited bandwidth connection. The user may also purchase a high-quality version of the selected media segment of interest at purchase stage 404. If the user's account is presently in good standing and the user wishes to purchase a media segment, the user is delivered the segment electronically over the network at media access 406. If the user's preferences indicate that a physical copy of the high-quality media is desired, then the purchased media may be delivered by postal mail. Media access 406 may connect to a network storage location in order to deliver the high-quality media segment to the requesting user. Such connection may be secure to prevent fraud, theft, or unauthorized access.

After the purchase of the media segment, the analysis and reports pages are regenerated at generate page stage 408. The user may then refine the search criteria or select another media segment of interest from the previous hit list. At return stage 410, the user is returned to the calling system or web page.

Referring next to FIG. 5, depicted is a sample web-based user interface which allows a user to review information about media clips that match certain user defined search criteria. Although Microsoft Internet Explorer is the depicted medium for the user interface, other media in the art are available for allowing user access to the system. In this example, the user is presented with web-based interface 501, which is accessible via any standard web-browser over any standard Internet connection or other similar network connection. Although interface 501 may be arranged in any fashion, in this example, it is divided into two panes; menu pane 503 and coverage pane 505. Menu pain comprises coverage tree 507 and clickable links. In the present example, coverage link 509, clips link 511, charts link 513, reports link 515, and settings link 517 and search field 519. Coverage tree 507 enables a user to quickly access the hits lists for different search parameters. In the example in FIG. 5, the user can select a hit list for “Home Depot”, “Restaurants”, “Wal-Mart”, or Walgreens.” As seen in FIG. 5, the user has chosen “Home Depot”, and so the hit list for “Home Depot” appears in coverage pane 505.

The interface enables a user to quickly navigate to other features of the user interface of the system of the present invention. Coverage link 509 enables a user to navigate to an interface through which the user can add additional coverage options. Clips link 511 enables a user to quickly navigate to a page with media clips corresponding to hit lists. Charts link 513 enables a user to navigate to a page of charts that gives a user information about the effectiveness of the user's advertising. Reports link 515 is similar and enables a user to navigate to a page of reports that gives a user information about the effectiveness of the user's advertising. Settings link 517 enables a user to navigate to a page through which that user can change settings. Finally, search field 519 enables a user to search hit lists, clips, reports, and other captured information for certain key words or phrases.

Coverage pane 505 includes display option 521, coverage option 523, and, in this example, three hits, hits 525, 527, and 529. Display option 521 and coverage option 523 enable a user to select the information she wants to view in coverage pane 505. Hits 525, 527, and 529 give information about media clips that matched the user-defined search criteria (in this case, the criteria being occurrences of “Home Depot”). In this example, information provided for each clip includes a clip abstract, information about when the clip aired, tone, dma, impressions, and availability.

Referring next to FIG. 6, depicted is a sample web-based user interface which allows a user to preview digital media segments and to review analyses of various media hits. In this example, the user is presented with web-based interface 601, which is accessible via any standard web-browser over any standard Internet connection. Although interface 601 can be organized or presented in a variety of fashions, in this example, it is divided into preview pane 603, and information pane 605. Preview pane 603 comprises video player 607, information field 609, and caption 611. Preview pane 603 enables a user to preview media clips before optionally purchasing these clips, downloading these clips, or sharing these clips with other users. A user selects a clip to preview, and video player 607 enables the user to interactively preview this clip. In a preferred embodiment, the video for that clip is streamed in a compressed format to (1) reduce necessary bandwidth, and (2) decrease the time a user has to wait before receiving the clip. It is contemplated that it can also include metadata in the stream. Information field 609 and caption 611 provide further information about the clip being viewed or the user defined search criteria which led to the clip being found by the system.

Interface 601 also comprises information pane 605, which gives user desired details about relevant media hits. In the example of FIG. 6, details for two hits, (i.e., Inside Edition hit 613, and Auto Week hit 615) are shown. In this example, the user created search parameters so that the system would generate a hit list comprising all media clips that contained references to a “Ford Mustang.” Each hit describes when and how the reference occurred, and provides other information including the name of the television program, the date, the time, the audience, and a value to the company.

In the example of FIG. 6, the first hit, Inside Edition hit 613, was a visual reference to a Ford Mustang. Importantly, this hit would be missed by traditional systems which merely analyze closed captioning data. Here, instead the hit was generated by a human monitor instructed to search according to the user defined parameters. Auto Week 615, on the other hand, was a hit generated by analysis of closed captioning data. Both hits 613 and 615 are clickable, enabling a user to preview the hits and if desired purchase the video associated with each hit.

For all human generated hits, such as Inside Edition hit 613, a user-defined tonality may be associated with the hit. For example, the tonality may be positive, negative, or neutral. Alternatively, any other scale for measuring tone can be utilized in accordance with the present invention, such as a graphical depiction. In one embodiment, a positive tonality can be indicated by an icon, such as a green icon, a negative tonality can be indicated by another icon such as a red icon, and a neutral tonality can be indicated by a third icon, such as a yellow icon.

Thus, the system of the present invention enables a user to understand how a product is being viewed by the general public. Interface 601 enables a user to quickly browse hits to effectively gain this understanding. While FIG. 6 is an example of the present system providing broadcast media hits, it is to be understood that the invention can provide similar information for all types of media such as print, Internet, radio, satellite, etc.

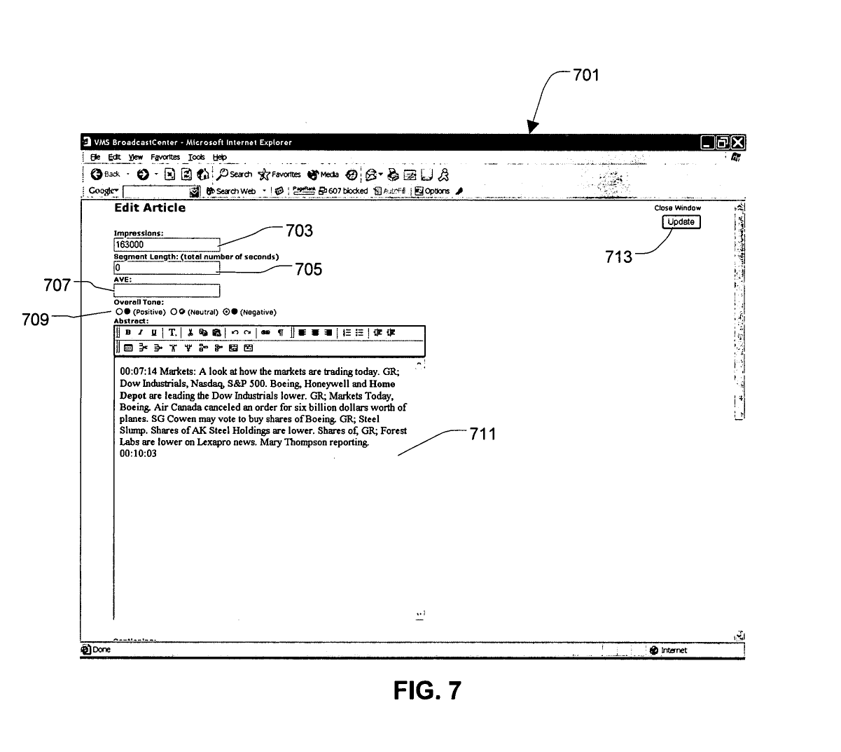

Next, referring to FIG. 7, depicted is a sample web-based interface that enables a user to view and edit the meta-data associated with a media clip. In the example shown in FIG. 7, edit article interface 701 comprises impressions field 703 segment length field 705, ad equivalency field 707, tone buttons 709, text field 711, and update button 713. Impressions field 703 lets the user edit the number of impressions for the given media clip. Segment length field 705 lets the user edit the length of the associated media clip. If the hit is an editorial, the user can view or set the ad-value equivalency (AVE) for that editorial.

Tone buttons 709 enable a user to assign a tone value to the clip, in this example, positive, neutral, or negative. Positive means that the overall tone of the article was positive with respect to how the user's product or service was described. Negative means the representation of the product or service was unfavorable. Neutral means the tone was neither positive nor negative. Finally, text field 711 enables a user to edit the text associated with the media clip. Any editor may be embedded including those that provide formatting, and other normally available text editing options. Update button 713 lets the user update the article after editing is finished.

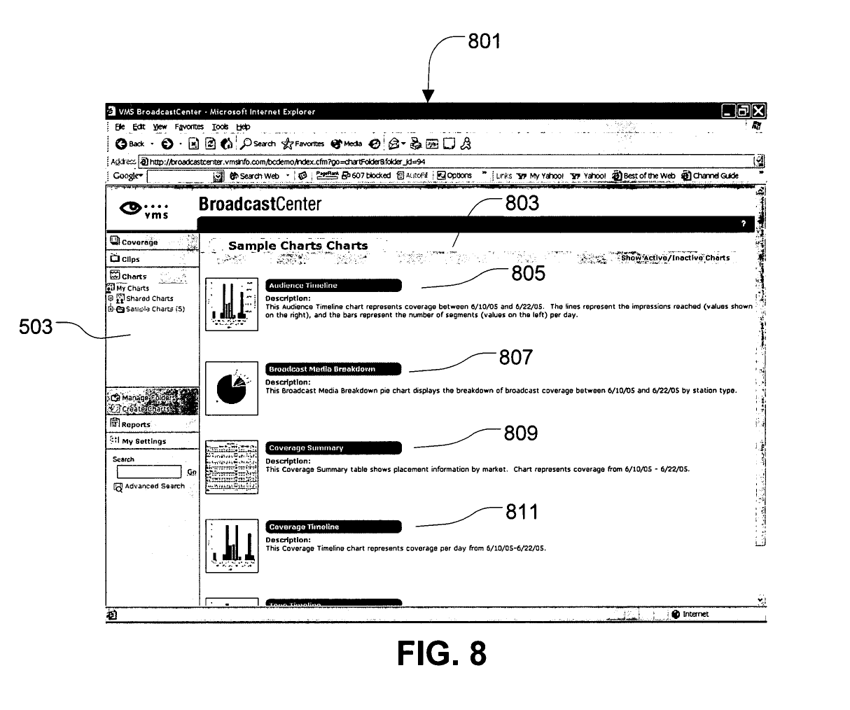

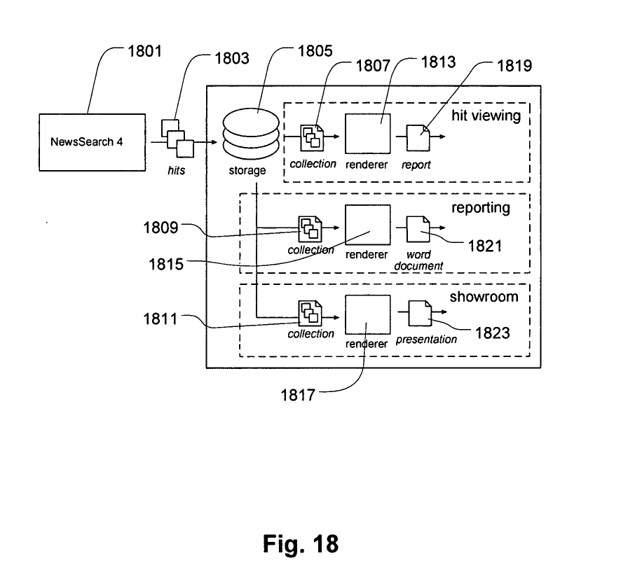

Next, referring to FIG. 8, depicted is chart list interface 801, which like interface 501 (see FIG. 5, supra), is divided into two panes, menu pane 503 (which also was discussed with respect to FIG. 5, supra), and report list pane 803. Report list pane 803 lists reports that are available to the user. Reports may come in a variety of forms, but generally are used to indicate to a user how the user's product or service is being conveyed to the public via the media. Reports are generated by renderers, which are discussed with respect to FIG. 18, infra. Alternatively, reports can be personalized by the user.

Reports may take a variety of forms (e.g., charts, tables, graphs, pie-charts, descriptions, presentations), and be available in a variety of formats (PDF, Microsoft Word, Microsoft Excel, Microsoft PowerPoint, etc.). Each available report is listed in report list pane 803. In the example shown in FIG. 8, audience timeline report 805, broadcast media report 807, coverage report 809 and coverage timeline report 811 are available to be viewed by the user. A thumbnail version of the report is displayed to the user, along with a title for the report, and a brief description. This information enables a user to quickly find the report of interest. If a user selects one of audience timeline report 805, broadcast media report 807, coverage report 809, or coverage timeline report 811, the user is taken to a web-page that displays a larger version of the report. The web-page may also have means through which the user can download the report, publish the report, share the report with other users, or add the report to a collection of reports.

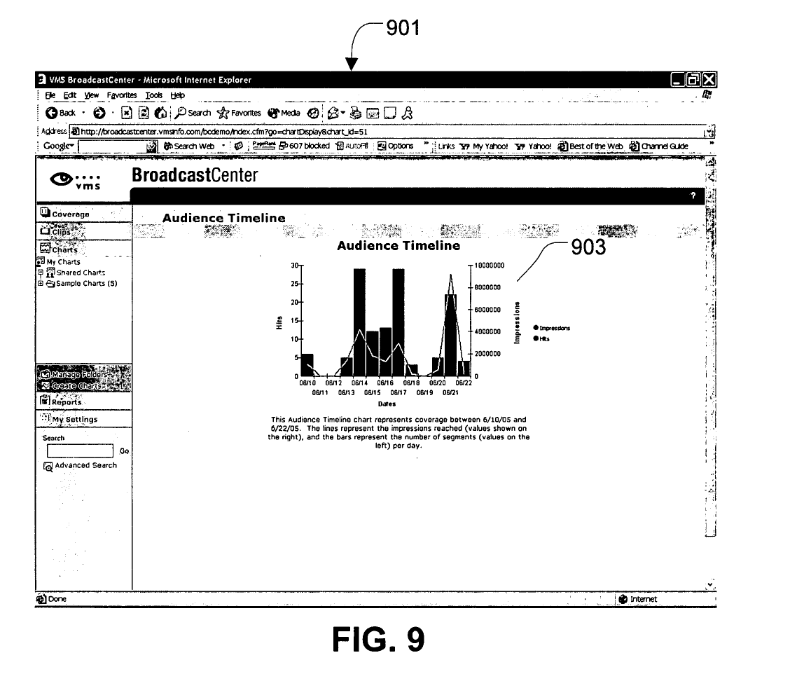

The system of the present invention enables a user to create reports which indicate the effectiveness of the user's advertising. Reports also indicate how a product is being described in the news, commercials, editorials, television shows, etc. Reports are generated according to user defined criteria. Sample reports will now be discussed with respect to FIGS. 9-14.

FIG. 9 depicts audience timeline chart 901 that graphs the audience timeline for a given search criteria over the span of thirteen (13) days. In audience timeline chart 901, the number of hits per day is graphed, along with the number of impressions. There is also a description for the chart. A user can create a chart that will dynamically update as hits are found by the system. Alternatively, the report can be static.

The chart depicted in FIG. 9 is beneficial to a user because it enables the user to gauge the saturation of a product's advertising in a given market. The hits information shows how often a product is being mentioned per day.

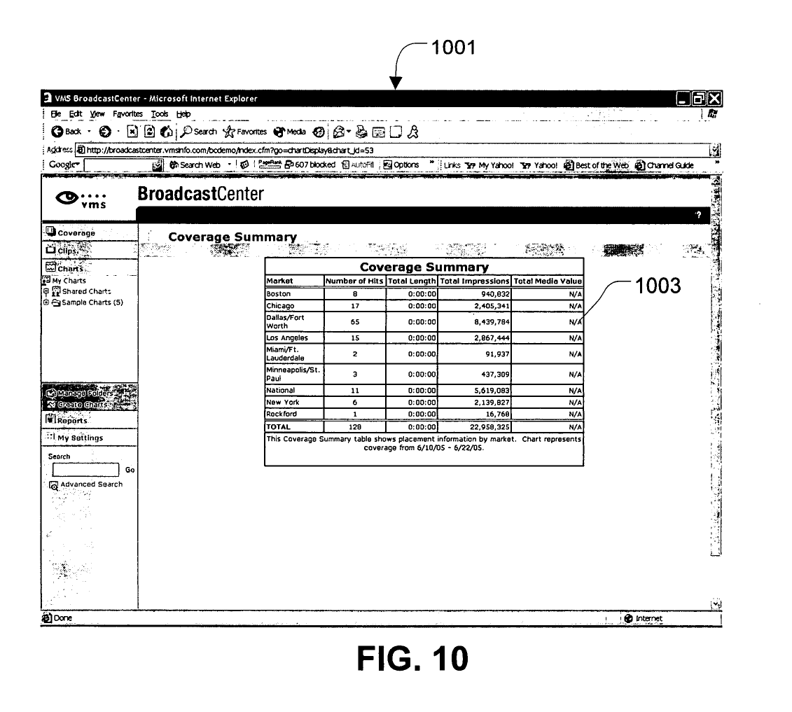

Next referring to FIG. 10, depicted is coverage summary table 1001. Coverage summary table 1001 comprises market column 1003, hits column 1005, length column 1007, impressions column 1009, media value column 1011, total row 1013, and description field 1015. From coverage summary table 1001, a user can gauge the hits, coverage length, impressions and media value for a product in any of the listed markets. The user can also quickly ascertain a total number of hits, total length of coverage, total impressions and total media value for all markets. Description 1015 is especially useful if the user wishes to share coverage summary table 1001 with other users or guests.

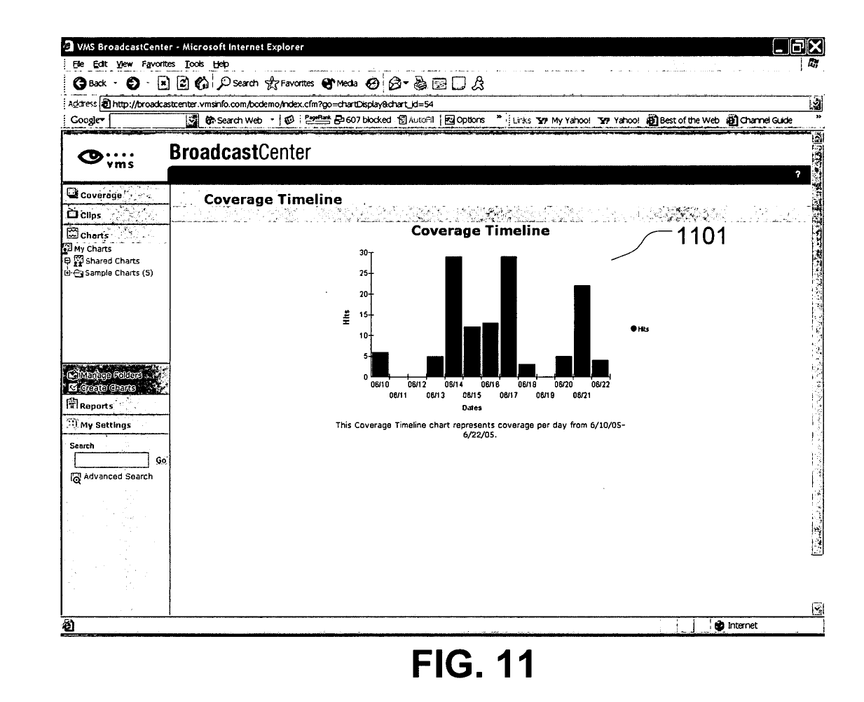

Next, FIG. 11 depicts coverage timeline chart 1101. Coverage timeline 1101 comprises information about how frequently a user's product or service is being “covered” by media broadcast. In coverage timeline 1101, the number of hits per day is used as a rubric to gauge this understanding.

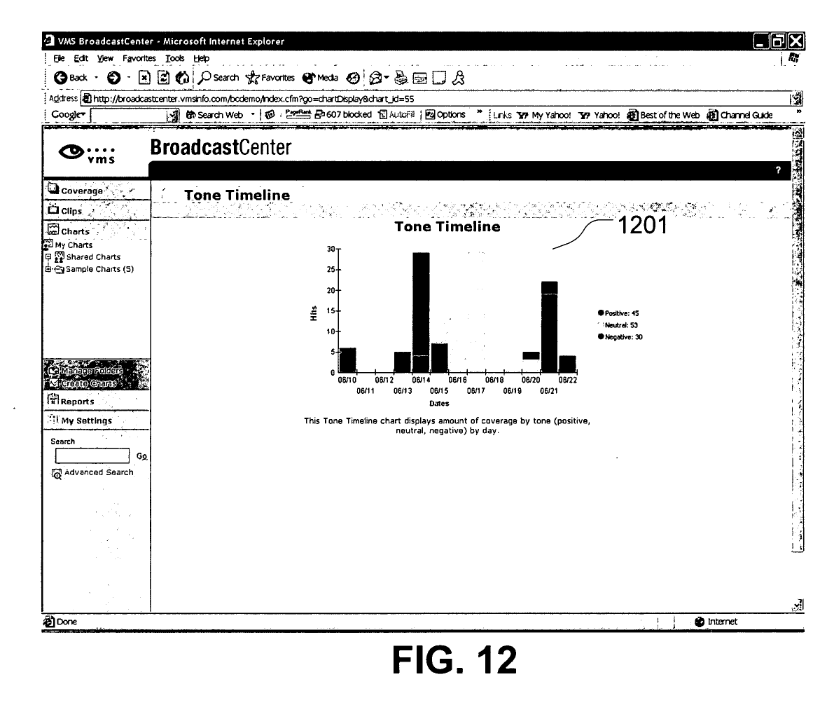

FIG. 12 depicts tone timeline 1201. Tone timeline 1201 is a graphical representation related to how a product is being reported to the public. For each hit, a “tone” can be assigned. A tone, in this example may be positive, neutral, or negative. It is also contemplated that any other scale for tone can be utilized in accordance with the present invention. For example, if there is an editorial about a user's product, the editorial may be positive (i.e., favorable), negative (i.e., unfavorable) or neutral. Other categories can also be established. Tone timeline 1201 gives a total number of positive hits, neutral hits and negative hits for each day over a given time period. FIG. 12 is merely exemplary—reports may also be generated in pie-chart forms and other forms to enable a user to gauge the tone of the reporting on that user's product.

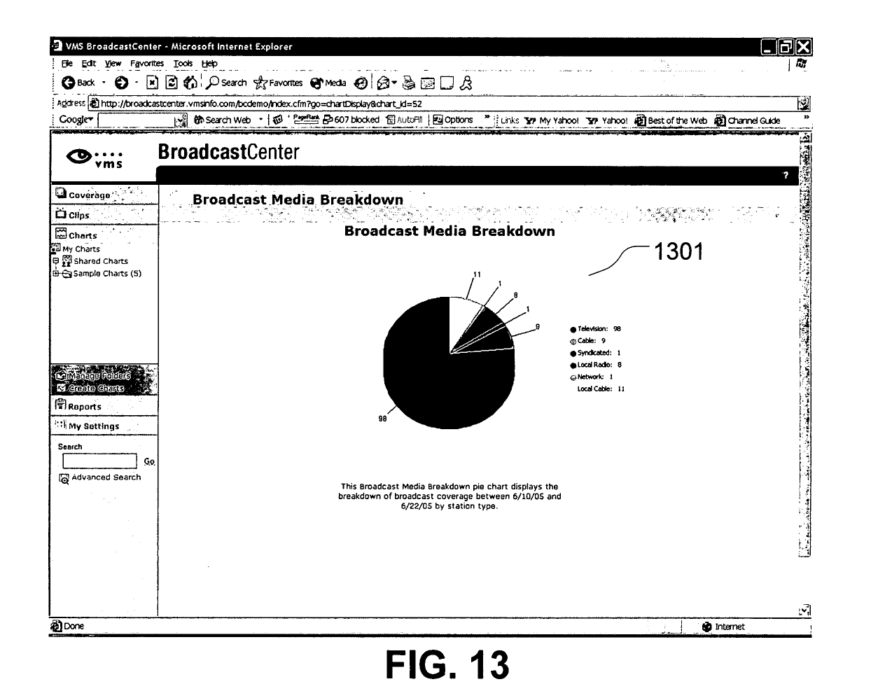

Broadcast media breakdown pie chart 1301 is presented in FIG. 13. In the example shown in FIG. 13, broadcast media breakdown pie chart 1301 represents the number of hits for each type of broadcast media monitored over a thirteen day period. The types of media monitored include television, cable, syndication, local radio, network, and local cable. As described above, the system of the present invention can monitor media from all types and sources including television, radio, the Internet, and print media. Indeed, although the sample chart of FIG. 13 focuses on television, this chart is merely exemplary, and is not meant to be an exhaustive list of the types of media monitored by the system of the present invention.

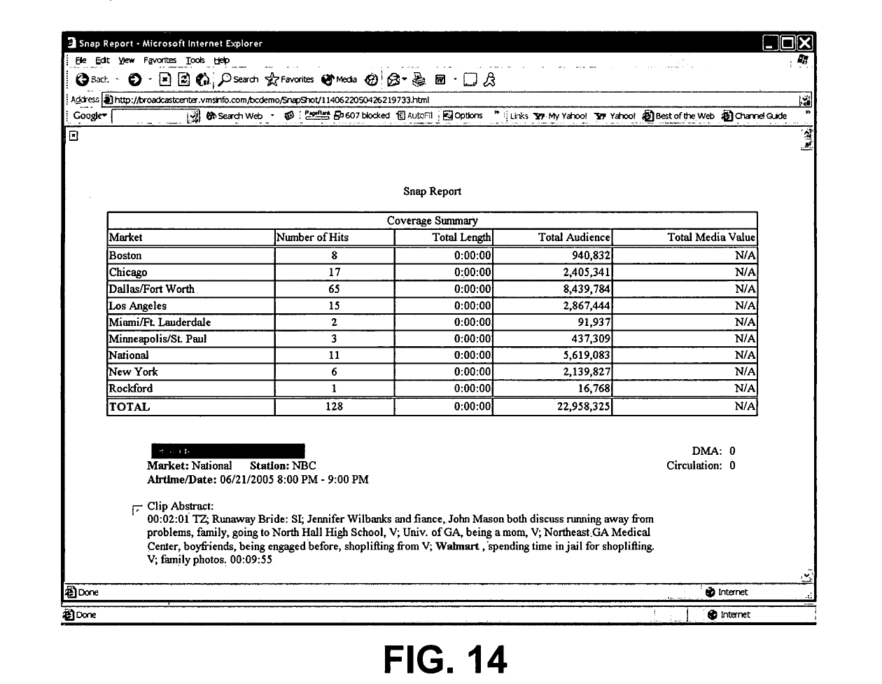

Turning next to FIG. 14, depicted is snap report 1401.

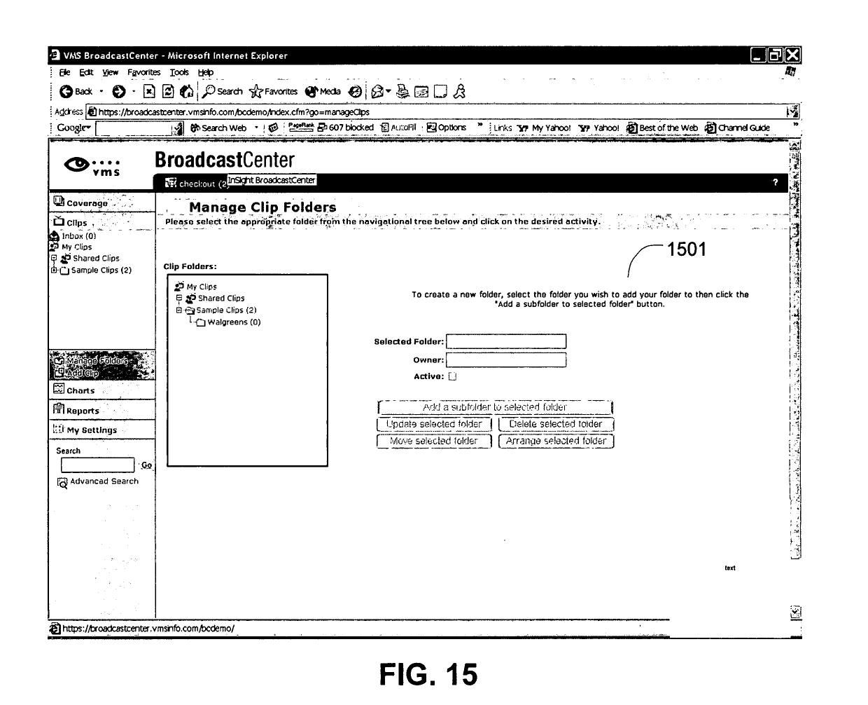

Next, referring to FIG. 15, depicted is clip management interface 1501. Clip management interface 1501 enables a user to add clips and remove clips to and from different user-defined folders. Essentially, the present invention provides a clip management system similar to the file management systems employed by modern operating systems. Included with this system may be the ability to set certain accessing, viewing, and editing permissions for clips. A user can also name and organize folders and sub-folders, placing clips in these folders as desired.

Shopping cart 1601 is depicted in FIG. 16. Shopping cart 1601 enables a user to purchase media clips. Shopping cart 1601 comprises clip 1603, clip 1605, update cart button 1606, and checkout button 1607. Shopping cart 1601 enables a user to select a format delivery for each clip via media format selection list 1609. The format of the delivery may be any standard format including VHS, tape, Audio tape, Beta, DVD, Mpeg, QuickTime format, streaming video, a proprietary format, etc. Shopping cart 1601 also provides information to the user about each clip, including a title, abstract, availability, market, station, airtime, date, etc. Generally the information provided will depend on the media clip type.

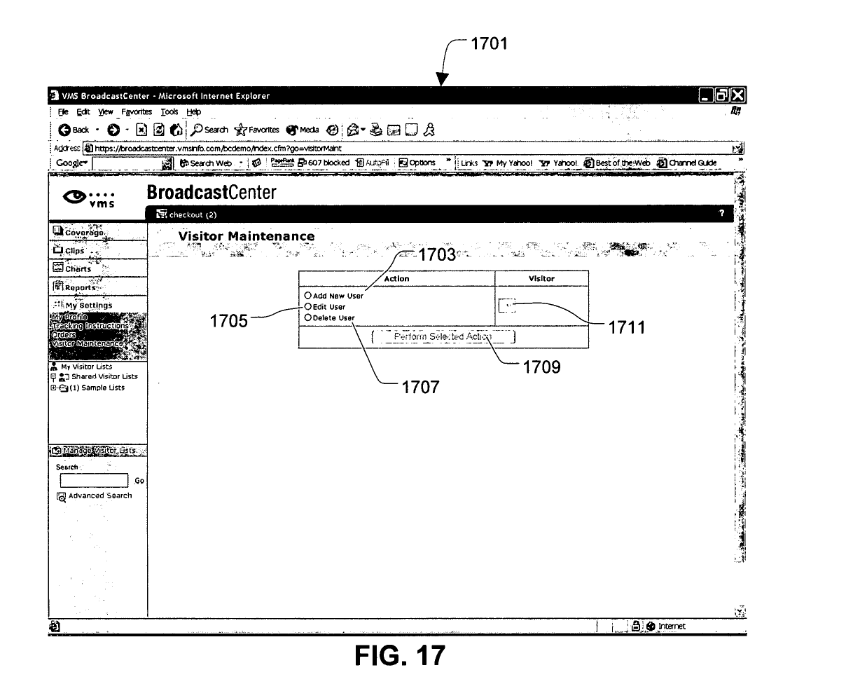

Next, referring to FIG. 17, shown is visitor maintenance interface 1701. Visitor maintenance interface 1701 comprises add new user button 1703, edit user button 1705, delete user button 1707, perform action button 1709, and visitor pull-down list 1711. As described above, a user can manage other user accounts, assigning certain permissions to these other users. This allows a user to publish reports to be viewed by other users, and to share media clips. For example, these features would enable an advertising firm to display reports and clips to show the effectiveness of one of its advertising campaigns.

To perform the user management operations, a user employs visitor maintenance interface 1701. First, to add a new user, the user would select add new user button 1703, followed by perform action button 1709. To edit an existing user, the user would select edit user button 1705, choose an existing user from visitor pull-down list 1711, and then select perform action button 1709. Finally, to delete a user, the user would select delete user 1707, then select an existing user from visitor pull-down list 1711 and select perform action button 1709. The aforementioned method for adding, editing and deleting users is merely exemplary and any other similar method may be used. Via these methods, a user can control who accesses media clips found by the system of the present invention.

FIG. 18 depicts the architecture of the renderers employed by the system of the present invention to generate collections, reports, tables and graphs in accordance with one embodiment of the present invention. First, a module, herein referred to as News-Search 1801, interfaces with one or more databases of stored media (e.g., network storage 142 from FIG. 1), to retrieve hits 1803, which match user-defined criteria. These hits are then stored in local database 1805. From local database 1805, users can generate collections of hits using the web-based interface described above. In the example depicted in FIG. 18, a user has generated three collections, hit collection 1807, report collection 1809, and showroom collection 1811.

From a collection, a renderer is used to generate a report, or other similar file which can be viewed, downloaded, published, emailed, etc. In the example of FIG. 18, renderer 1813 generates report 1819, renderer 1815 generates document 1821, and renderer 1817 generates presentation 1823. Report 1819, document 1821 and presentation 1823 enable a user to understand how effective a business' advertising campaign is. Notably, the system of the present invention is not limited to rendering reports, documents and presentations. As described above, the system can also render charts, graphs, spreadsheets, web-pages, slideshows, or any other format that may be useful for a user to understand how a product or service is conveyed to the market via the media.

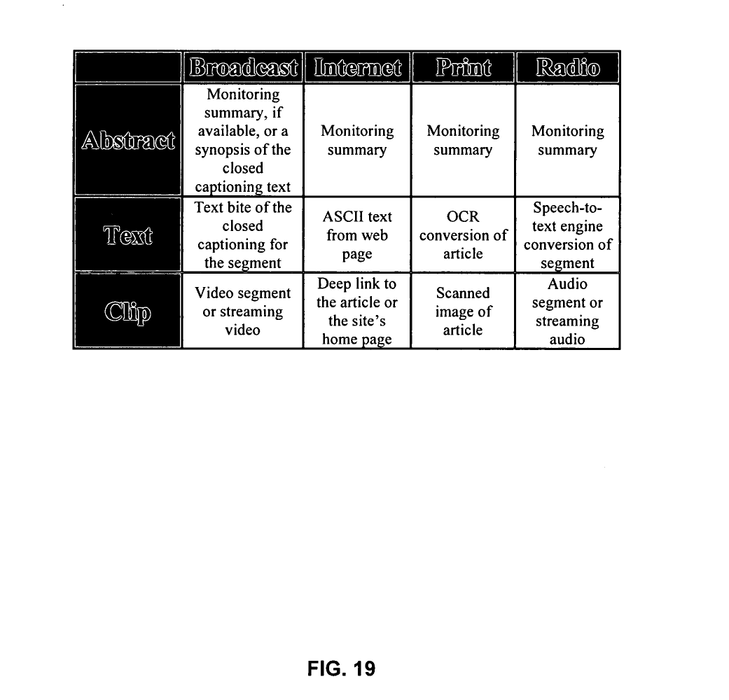

Finally, referring now to FIG. 19, a table is shown illustrating a sampling of the available media displays in accordance with one embodiment of the present invention. Three main displays are offered to a user of the present invention for each media segment monitored. Although three forms of display—abstracts, texts, and clips—are envisioned, other forms of media display may also be utilized in accordance with the present invention. Abstract displays across all four main media sectors—broadcast, Internet, print, and radio, and any other means for advertising—comprise monitoring summaries, which are typically created and reviewed manually by editorial staff members to ensure a high degree of accuracy and relevance. These monitoring summaries comprise cogent synopses of monitored media for quick review and may additionally include attributes pertaining to the media segment, such as title, author, date, length, station, publication, impression count, and ad value equivalence. Monitoring summaries may also include tonality indications and other staff-derived classifications. If monitoring summaries are not available for broadcast media, then a synopsis of the closed captioning script is provided as an alternative to the monitoring summary.

Text displays comprise full text versions of the monitored media segment. For broadcast media, the text display comprises the text of the closed captioning data for the media segment. Alternatively, speech to text engines may be used to generate this text. If closed captioning is used, the text bite may be the complete closed captioning stream, or any formatted or abridged derivative thereof. The text display for media derived from the Internet is typically the ASCII text from the web page itself. This text may be derived from the source HTML code of the Internet media, a data feed service (e.g., RSS, XML data feed), or any other Internet text or news delivery routine. For print media, text displays typically comprise the OCR and edited conversion of the print article. Similarly, radio segments may also be converted to text form via a speech-to-text engine, speech recognition module, or other like forms of speech conversion routines.

Still referring to FIG. 19, clip displays may comprise segments of video or audio, or streaming video or audio for broadcast and radio media. Video and audio segments are actual media segments as aired encoded in Windows Media, QuickTime, Real Video, or other format suitable for network transmission. As is common in the art, these segments may be played or streamed directly to a web browser or media application. The segments may be encoded or compressed as necessary. Clip displays for Internet media comprise a deep hyperlink where the article can be found (or the hosting site's home page, if the deep link is unavailable or access is restricted). This link affords a user simple, one-click access to the actual monitored Internet media (or a cache or copy thereof). Finally, for print media, the clip display comprises a scanned image of the print article or advertisement. This scanned image may comprise high-resolution graphics as well as text and other embedded information objects.

From the foregoing description of the preferred embodiments, which embodiments have been set forth in considerable detail for the purpose of making a complete disclosure of the present invention, it can be seen that the present invention comprises a method for integrated media monitoring, purchase, and display over a network. It will be appreciated by those skilled in the art that changes could be made to the embodiment described above without departing from the broad inventive concept thereof. It is understood, therefore, that this invention is not limited to the particular embodiment disclosed, but it is intended to cover all modifications that are within the scope and spirit of the invention as defined by the appended claims.

What is claimed is:

1. A method for analyzing broadcast media, said method comprising:
digitally recording media segments from at least one source as digital media segments;
retrieving a subset of said digital media segments according to user-defined criteria;
storing said subset in a database;
analyzing said subset to generate at least one report; and
displaying said report to a user.

2. A method according to claim 1 wherein said report comprises a chart.

3. A method according to claim 1 wherein said report comprises a table.

4. A method according to claim 1 wherein said report is a webpage.

5. A method according to claim 1 wherein said media segments comprise closed captioning data.

6. A method according to claim 5 wherein said retrieving searches said closed captioning data according to said user-defined criteria.

7. A method according to claim 1 wherein said retrieving comprises human monitoring and closed captioning analysis.

8. A method according to claim 7 wherein said analyzing utilizes said human monitoring and said closed captioning analysis.

9. A method according to claim 1 wherein a user inputs said user-defined criteria via a web-based interface.

10. A method according to claim 1 wherein said report comprises data selected from the group consisting of impressions, ad-value equivalency (AVE), audience size, market segment, media relevancy, and tone.

11. A method according to claim 10 wherein said tone is measured on a scale.

12. A system for analyzing media broadcast, said system comprising:
servers for searching media databases;
servers for retrieving media segments from multiple sources;
media databases linked to said servers for storing said media segments as digital media segments;
processors linked to said databases for analyzing said digital media segments according to user-defined criteria;
hit-list databases linked to said media databases and said processors for storing subsets of said digital media segments, wherein said subsets match said user-defined criteria, and wherein said hit-list databases further store lists corresponding to said subsets; and
a web server linked to said hit-list databases for displaying said lists and said subsets to a user via a web-based interface.

13. A system according to claim 12 wherein reports indicative of said subsets are displayed to said user via said web-based interface.

14. A system according to claim 13 wherein said reports comprise charts.

15. A system according to claim 13 wherein said reports comprise tables.

16. A system according to claim 13 wherein said reports are web-pages.

17. A system according to claim 13 wherein said reports comprise data selected from the group consisting of impressions, ad-value equivalency (AVE), audience size, market segment, media relevance, metadata, and tone.

18. A system according to claim 17 wherein said tone is measured on a scale.

19. A system according to claim 12 wherein said processors analyze closed-captioning data associated with said media segments.

20. A method for enabling a user to ascertain advertising effectiveness, said method comprising:
capturing media segments from multiple media sources;
storing said media segments as digital media segments;
filtering said digital media segments to generate digital media subsets and user-specific hit lists;
analyzing said digital media subsets to generate reports, wherein said reports are indicative of advertising effectiveness; and
displaying said digital media subsets, said user-specific hit lists and said reports through a web-based interface.

21. A method according to claim 20, wherein said advertising effectiveness is determined by analyzing said media subsets for tone.
